(19) United States
(12) Patent Application Publication
(10) Pub. No.: US 2013/0138521 A1
(43) Pub. Date: May 30, 2013

(54) Contactless Payment System Providing Supplemental Content Associated with the Transaction

(71) Applicants: Roy Want, Los Altos, CA (US); Richard Gossweiler, Sunnyvale, CA (US); Colin Albright McDonough, Austin, TX (US)

(72) Inventors: Roy Want, Los Altos, CA (US); Richard Gossweiler, Sunnyvale, CA (US); Colin Albright McDonough, Austin, TX (US)

(73) Assignee: GOOGLE INC., Mountain View, CA (US)

(21) Appl. No.: 13/308,169

(22) Filed: Nov. 30, 2011

(51) Int. Cl. G06Q 30/06

(52) U.S. Cl. 705/26.1

(57) ABSTRACT

A wireless communication device configured to transmit and receive near-field communication including data associated with the purchase of a product. Supplemental content associated with the purchased can be identified by the wireless device and/or a merchant device and provided to the wireless device. Supplemental content may include machine-readable and machine-storable work product and instruction, document, electronic media, computer-implemented instructions, or any form of content that can exist in a computer-based environment. The supplemental content may be determined based on information about the user, information about the product or service being purchased, and information about the point-of-sale.

### TECHNICAL FIELD

The present disclosure relates generally to systems, methods, and computer programs for managing multiple contactless payment applications and providing supplemental content in response to or in anticipation of a purchase.

### BACKGROUND

Point-of-sale or point-of-service (POS) devices are often used by consumers and merchants to complete purchase transactions. POS devices utilize contactless payment technology incorporate proximity-triggered communication between two devices in order to authenticate and enable payment for goods and services over the air (OTA). Information related to the purchase transaction is transmitted between the consumer's device and the merchant's POS device without physical connection. In general, the information exchanged between the consumer and the merchant is directed to purchase-specific content such as purchase price, payment method, security authentication, ticketing, etc. There is limited interaction with the user including additional or supplemental content regarding, or ancillary to, the purchase transaction. Thus, a need in the art exists for systems and methods that provide additional content to a user accompanying the standard transaction data.

### SUMMARY

An aspect of the present invention provides a method for providing data to a wireless device. The method may include providing purchase data via near-field communication to the wireless device and receiving, via near-field communication from the wireless device, purchase authorization data at a payment module logically coupled to/resident on a merchant device. The method may further include identifying, by the merchant device, supplemental data and providing the supplemental data to the wireless device. The supplemental data may include instructions to download content associated with the supplemental data and instructions to schedule a calendar event.

Another aspect of the present invention provides a mobile wireless communication device. The mobile wireless communication device may include an electronic antenna circuit configured to transmit and receive data via near-field communication and control circuitry, coupled to the electronic antenna circuit, for controlling transmission of the data, including purchase authorization data, via near-field communication. The data received by the electronic antenna circuit may include purchase transaction data and supplemental data. The control circuitry may be configured to identify content associated with the supplemental data and instruct the electronic antenna to retrieve the desired content associated with the supplemental data.

Another aspect of the preset invention provides a wireless communication device utilizing near-field communications. The device may include an electronic antenna circuit including an antenna that may be configured to transmit and receive data via near-field communication between the device and a mobile device. The device may also include control circuitry coupled to the electronic antenna, the control circuitry may be configured to control transmission of the data to the mobile device, where the data may include purchase data and supplemental data associated with the purchase data. The control circuitry may provide the supplemental data to the mobile device in response to receipt of purchase authorization data from the mobile device. The supplemental data may include instructions to download content associated with the supplemental data and instructions to schedule a calendar event on a calendar associated with a user of the mobile device.

### BRIEF DESCRIPTION OF THE DRAWINGS

FIG. 1 is a block diagram depicting an operating environment of a payment system in accordance with certain exemplary embodiments.

FIG. 2 is a block diagram depicting a general component architecture of a computer system, in accordance with certain exemplary embodiments.

FIG. 3 is a flow chart depicting a method for processing a contactless payment transaction with certain exemplary embodiments.

### DETAILED DESCRIPTION

The present disclosure is directed to a contactless payment system that provides a user with supplemental content in response to or in anticipation of a purchase transaction. Determination of the relevant supplemental content may take into account information about the user, information about the product or service being purchased, and information about the point-of-sale (e.g., time of day, location, type of store, type of transaction being consummated, etc.). The overall system architecture as well as the use of a contactless payment system providing a consumer with supplemental content is described.

As used throughout the specification, the term “content” is to be broadly interpreted to include any machine-readable and machine-storable work product and instruction, document, electronic media, computer implemented-instructions, etc. Exemplary content may include, for example, electronic media (image files, audio files, video files, web casts, podcasts, etc.), information contained in documents, or any other form of information that can exist in a computer-based environment.

As used throughout the specification a “document,” as the term is used herein, is to be broadly interpreted to include any machine-readable and machine-storable work product. A document may include, for example, an e-mail, a web site, a calendar or calendar entry, a file, a combination of files, one or more files with embedded links to other files, a news group posting, a blog, a blog post, advertisement, any of the aforementioned content, etc. In the context of the Internet, a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to or from a document to or from another document or another part of the same document.

The term “supplemental content,” as the term is used herein, is to be broadly interpreted to include any content which may be selected by a user, recommended to a user (e.g., based on user information, purchased product or service, and point-of-sale information), automatically selected based on user information, and/or any combination of the three.

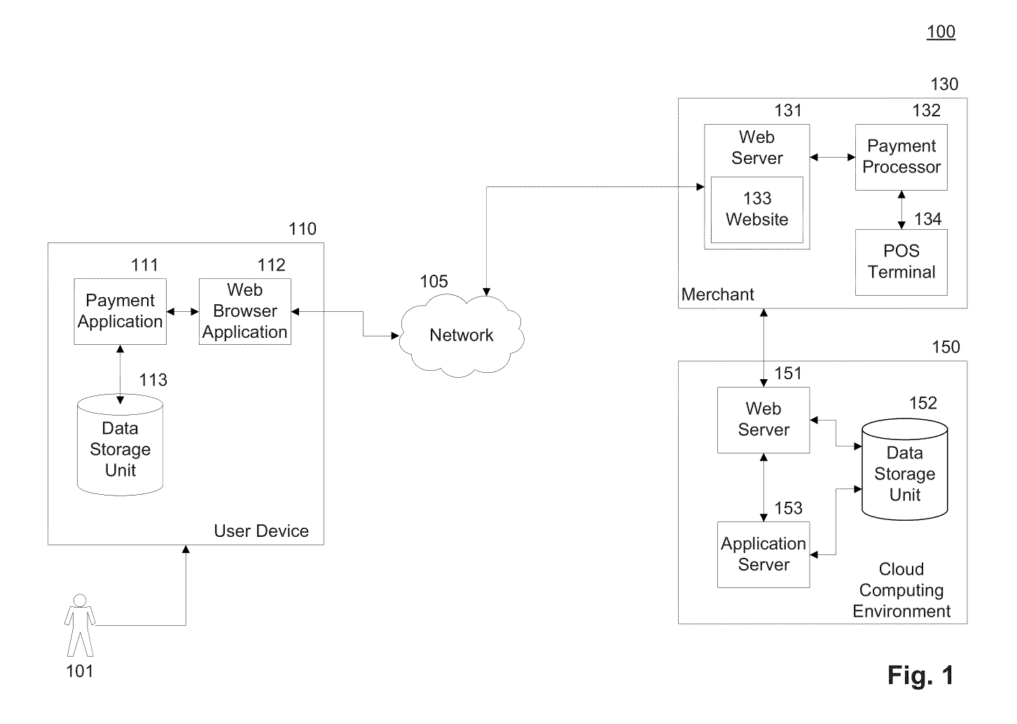

FIG. 1 illustrates the main components of operating environment 100 for a payment system in accordance with certain exemplary embodiments. The payment system can be embodied as a stand alone application program or as a companion program to a web browser having messaging and storage capabilities. While certain embodiments are described in which parts of the payment system are implemented in software, it will be appreciated that one or more acts or functions of the payment system may be performed by hardware, software, or a combination thereof, and may be embodied in one or more computing systems.

An exemplary operating environment 100 includes a user device 110 associated with a user 101, a merchant system 130, and a cloud computing environment 150.

In an exemplary embodiment, the user device 110 can enable a purchase of a product or service at a merchant's point-of-sale/point-of-service (POS) terminal 134 or via a merchant's website 133. The operating environment 100 can be used for multiple purposes, including financial transactions, coupons, ticketing, calendar scheduling, secure authentication, and related applications. The user device 110 may be a personal computer, mobile device, (e.g., notebook computer, tablet computer, netbook computer, e-Reader, personal digital assistant (PDA), video game device, GPS locator device, cellular telephone, smartphone, or other mobile device), electronically enabled key fob, electronically-enabled credit card-type card, or other appropriate technology that is Near Field Communication (NFC) enabled or is coupled to an NFC enabled device, or coupled to a web browser application 112, such as GOOGLE'S CHROME, MICROSOFT'S INTERNET EXPLORER®, or MOZILLA'S FIREFOX®.

NFC is an example of a proximity communication method that enables contactless payment technology. NFC is supported by the Global System for Mobile Communications (GSM) Association and NFC enabled devices are supported via the International Organization for Standardization. In an exemplary embodiment, user device 110 and a merchant system 130 can utilize radio-frequency identification (RFID) as a proximity communication method adapted to enable NFC communication to transmit and receive information between the user device 110 and the merchant system 130.

In an exemplary embodiment, the merchant system 130 may include a payment processor 132 logically coupled to a merchant's POS terminal 134 and a web server 131. The POS terminal 134 may be an NFC enabled device configured to detect and retrieve data from the user device 110 using a short-range radio frequency field induced between antennas coupled with both the POS terminal 134 and the user device 110. Short communication distances, such as 3-4 inches, limit, as well as, enable secure communication between the POS terminal 134 and the user device 110. In an exemplary embodiment, the POS terminal 134 may be part of another device, such as a mobile phone with an NFC interface, a peripheral device connected to the operating environment 100, a peripheral device of a computer, etc.

NFC is supported by the International Electrotechnical Commission standard (ISO/IEC) 14443 for smart cards and readers. In an exemplary embodiment, an NFC enabled chip may be implemented, either independently or on existing components with the user device 110. NFC enabled chips include, for example, a SIM card, U-RIM card, an embedded chip or external SD card, or any type of smart card. In an exemplary embodiment, the user device 110 is a Code Division Multiple Access (CDMA) device with an embedded secure element within an NFC controller or a Re-usable Identification Module (R-UIM) type card. In an exemplary embodiment, the user device 110 is a GSM phone including an NFC controller with an antenna incorporated into the device with a secure contactless payment application 111 located on a smart chip. The smart chip can be further incorporated into one of several exemplary phone components, including a standard Subscribed Identity Module (SIM) card, a separate Mobile Secure Digital Card (for example, a secure digital (SD) card with non-volatile memory, such as EEPROM), or an embedded chip.

The user device 110 can operate in an active mode or passive mode in response to the POS terminal 134. In an exemplary embodiment, the user device 110 operates passively where the POS terminal 134 provides a carrier field and the user device 110 answers by modulating the existing field. In another exemplary embodiment, the user device 110 operates actively where both the POS terminal 134 and the user device 110 communicate by alternately generating their own field.

In an exemplary embodiment, the user device 110 can enable purchases at a merchant's website 133 operating on the web server 131. In such embodiments, the user device 110 may include or be coupled to a web browser application 112, such as GOOGLE'S CHROME, MICROSOFT'S INTERNET EXPLORER®, or MOZILLA'S FIREFOX®. For example, in an exemplary embodiment the user device 110 is a GSM phone enabling the user device 110 to secure bank information from an authenticating server called a trusted service manager (TSM). The bank information is used for payments on the merchant website 133. The TSM hosts and controls all credit card information sent to or withdrawn from the trusted NFC enabled user device 110.

Using the web browser application 112, the user 101 can complete a purchase transaction at a merchant's website 133 and also view, download, upload, or otherwise access documents or web pages via a distributed network 105. The network 105 includes a wired or wireless telecommunication system or device by which network devices (including devices 110, 130, and 150) can exchange data. For example, the network 105 can include a local area network (LAN), a wide area network (WAN), an intranet, an Internet, or any combination thereof.

The user device 110 also includes a payment application 111. The payment application 111 can interact with the POS terminal 134 and web browser application 112 or can be embodied as a companion application of the web browser application 112. As a companion application, the payment application 111 executes within the web browser application 112. That is, the payment application 111 may be an application program embedded in the web browser application 112. The web browser application 112 can interact with web servers (or other computing devices) connected to the network 105, such as web server 131 of the merchant system 130 and/or web server 151 of the cloud computing environment 150.

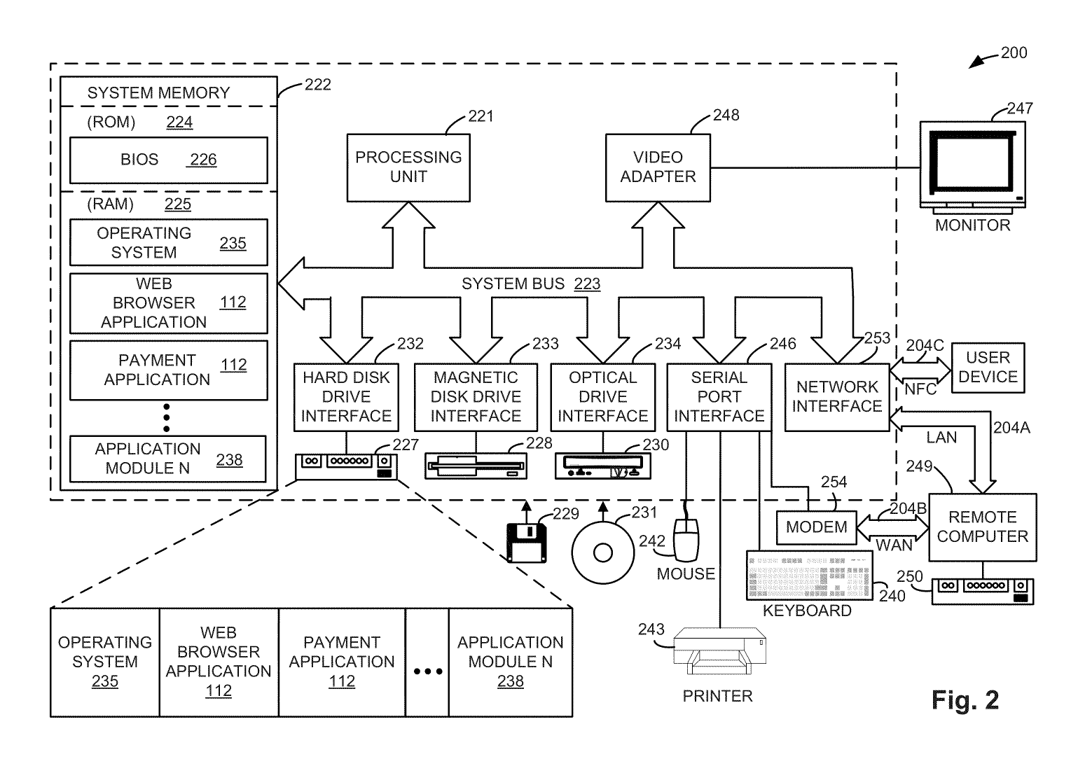

The user device 110 includes a data storage unit 113 accessible by the POS terminal 134, the payment application 111 and the web browser application 112. The exemplary data storage unit 113 can include one or more tangible computer-readable storage devices as discussed below with reference to FIG. 2. The data storage unit 113 can be stored on the user device 110 or can be logically coupled to the user device 110. For example, the data storage unit 113 can include on-board flash memory and/or one or more removable memory cards or removable flash memory.

The exemplary payment application 111 enables storage of one or more payment options that can be used for purchases made at a merchant's POS terminal 134 or via a merchant's website 133. Each payment option can include or be associated with a financial account, such as a credit card account, a debit card account, a checking account, a savings account, a loyalty rewards account, or other type of account that can be used to make a purchase. The payment application 111 can store, for each payment option, information associated with the financial account for that payment option. The payment information can also include information associated with the user 101, such as name, contact information (e.g., residential address, phone number, e-mail address), demographic information, or any other suitable information associated with the user 101. The payment information also can include shipping information, such as one or more shipping addresses, preferred shipping provider(s), and preferred shipping method(s). The payment information for each payment option can be maintained by the payment application 111 and stored in the data storage unit 113.

The user 101 can interact with a user interface provided by the payment application 111 to add, modify, or remove payment information from the payment application 111. In a web browser companion application embodiment, this user interface can be provided via the web browser application 112. In addition or in the alternative, the payment information may be synchronized with a remote storage location, such as the cloud computing environment 150. In such an embodiment, the user 101 can access the payment information stored at the remote location using another device, such as a desktop computer connected to the network 105. The remote storage location can update the payment application 111 in response to any changes made at the remote storage location.

The payment option(s) stored in the payment application 111 can be used to complete purchases from merchants via a merchant's POS terminal 134 or a merchant's website 133 operating on the web server 131. In certain exemplary embodiments, each merchant's website 133 (operating on the web server 131) that accepts payment via a payment application 111 can include a set of computer-readable program instructions, for example, using JavaScript, that enable the merchant's website 133 to interact with the payment application 111.

The merchant system 130 includes a payment processor 132 logically coupled to the POS terminal 134 and the web server 131. The payment processor 132 can receive payment information from the POS terminal 134 or the web server 131 and interact with the financial institution (not shown) or an acquirer (not shown) to authorize payment information.

To complete a purchase via a POS terminal 134, the user device 110 may interact with the POS terminal 134 using NFC communication. In an exemplary embodiment, once an NFC connection has been established, the POS terminal 134 can send a purchase request message to the payment application 111 of the user device 110 requesting payment information. The purchase request message can also include information regarding the requested purchase, including information concerning the product(s) for purchase (e.g., name and/or description of each product, price for each product, total price, etc.), information regarding the merchant system 130 (for example, merchant name, payment methods accepted by merchant, etc.), and requests for the user 101 to provide additional information.

In response to receiving a purchase request message from the merchant's website 133, the payment application 111 can present a user interface to the user 101 for the user 101 to confirm the purchase. In an exemplary embodiment, the user interface displayed by the payment application 111 also can display all or a portion of the information in the purchase request and an actuatable button or link for the user 101 to confirm the purchase. This user interface also can allow the user 101 to select from multiple payment options stored by the payment application 111 to use as payment for the product(s) and from multiple shipping options.

If the user 101 confirms the purchase, the payment application 111 can retrieve the information requested in the purchase request message, generate a merchant request message that contains the information and the confirmation, and transmit the merchant request message to the merchant's POS terminal 134. If the purchase is authorized via the payment processor 132, the merchant's POS terminal 134 can transmit an electronic confirmation and/or a receipt to the payment application 111. The payment application 111 can store the confirmation and/or receipt at data storage unit 113 of the user device 110 and also synchronize storage with the data storage unit 152 of the cloud computing environment 150.

In an exemplary embodiment, the purchaser website 133 can be used to complete the purchase transaction. For example, the user 101 may indicate via the web server application 112 a desire to purchase a merchant's product(s), the merchant's website 133 can present a user interface in the form of a web page to receive payment information from the user 101. The merchant's website 133 sends a purchase request message to the payment application 111 requesting payment information, the user 101 can confirm the purchase, and the payment application 111 can transmit the merchant request message to authorize the purchase.

In certain exemplary embodiments, the payment application 111 can generate a receipt for a purchase rather than or in addition to receiving a receipt from the merchant's website 133. For example, the payment application 111 can generate the receipt using the information in the purchase request message received from the POS terminal 134/merchant's website 133 or from the merchant request message sent to the POS terminal 134/merchant's website 133. The receipt can include details of the completed purchase. For example, the receipt can include a list of products purchased, a description of each product purchased, the price for each product purchased, a product category for each product purchased, a total price, a stock keeping unit (SKU) or similar identifier for each product purchased, taxes paid, rebates for one or more of the products purchased, payment method used, discounts applied, the time and/or date of purchase, warranty information for one or more of the products purchased, or other suitable information. The receipt also can include information regarding the merchant system 130, including a name of the merchant associated with the merchant system 130, a description of the merchant system 130, the URL of the merchant's website 133, and any other suitable information regarding the merchant system 130.

In an exemplary embodiment the purchase request message and the receipt message can be provided with supplemental content regarding or ancillary to the purchase transaction. Supplemental content may include, for example, machine-readable and machine-storable work product and instruction, document, electronic media, computer-implemented instructions, or any form of content that can exist in a computer-based environment. In an exemplary embodiment, supplemental content comprising electronic media can include image files, audio files, video files, web casts, podcasts, etc. For example, electronic media can include an electronic wallpaper image, ring tone, song, album, podcast, video trailer, movie, television episode, etc. In an exemplary embodiment, the supplemental content can be an electronic document including, for example, an e-mail, web site, calendar event, file, combination of files, one or more files with embedded links to other files, a news group posting, blog post, or an advertisement. For example, the supplemental content can include terms and condition of use data associated with the product. In an exemplary embodiment, the supplemental content may include a discount code/coupon and purchaser loyalty rewards data associated with the merchant or other related merchant(s). In another exemplary embodiment, the supplemental content can include content associated with individual other than the user 101. For example, the supplemental content may include information associated with other individuals who have purchased the same product, such as, product reviews, comments, or any other information created by other individuals related to the product, a listing of other individuals who have purchased the same or similar product, or a listing of other products purchased or considered for purchase by individuals who purchased the same product. For example, when the product is an event ticket, the supplemental content may include a listing of individuals also attending the event including a listing of individual associated with the user 101 also attending the event. Using the supplemental content, the user 101 is able to identify other users and other users associated with the user 101 who are also attending the event and identify any information created by the other users related to the event, e.g., status updates on social media website, reviews or comments about the event created by other users, etc.

In an exemplary embodiment, the supplemental content can include computer-implemented instructions. For example, when the purchase is related to an event, the supplemental content can include computer-implemented instructions to check the user's 101 digital calendar for availability and schedule a calendar event. The supplemental instructions also may include instructions to check another individual's digital calendar or to create an electronic invitation to schedule an event on another individual's digital calendar. By way of further example, the supplemental content can include computer-implemented instructions to direct the user's 101 interaction with a website, such as, to prompt the user 101 to change their status or otherwise provide an indication or information related to the user 101 on a website such as a social media website. In another example, the computer-implemented instructions can prompt the user to generate directions to a location associated with the product, e.g., the location of an event associated with the purchased product.

In another exemplary embodiment, the supplemental content may include information regarding the product made available after the user's 101 purchase date, such as, recall information or other safety information, a time or location change when the product is an event, and other ancillary information associated with the product, e.g., weather or traffic information associated with the time and location of an event associated with the product. In an exemplary embodiment, the supplemental content also may include non-computer-based content. For example, the supplemental content may include physical receipt by the user 101 of magazines, newspapers or periodicals, print advertisements, product samples, etc. The supplemental content may be any other content related to or ancillary to the purchase transaction.

The supplemental content can be identified based on a user 101 selection, recommended to the user 101 from the merchant system 103, and automatically selected at the merchant system 103 based on user 101 or merchant system 130 information. In an exemplary embodiment, the supplemental content is determined based on a user 101 request for additional content or a user's 101 indication that additional content may be provided. In an exemplary embodiment, supplemental content may be determined based on: user 101 information including location, demographic information, purchase history, social media status, other users associated with the user, etc.; information regarding the purchased product or service including advertisements for related products and information related to other users who have purchased the product or similar products; and information regarding the point-of-sale including location, type and cost of products generally sold by the merchant, surrounding merchant information, etc. For example, the user 101 can utilize the operating system 100 to purchase a movie ticket. In the present exemplary embodiment, supplemental content provided to the user 101 can include recommendations and/or discounts for other films potentially of interest to the user 101, computer-implemented instructions to schedule a calendar event on the user's 101 digital calendar or an event on another individual's calendar, a movie trailer or “sneak preview” of the movie or another movie, or information regarding theater concessions. By way of further example, the supplemental content may include content related to another merchant associated with the movie theater. For example, the supplemental content may include a digital coupon for food or beverage at a restaurant associated with the merchant, a ringtone or electronic media related to another merchant, a link to a website related to another merchant, etc.

The operating environment 100 can include a cloud computing environment 150. The exemplary cloud computing environment 150 includes the web server 151, one or more data storage units 152, and one or more application servers 153. The cloud computing environment 150 may be provided by the provider of the payment application, by a merchant 130, or by another party. In certain exemplary embodiments, multiple cloud computing environments 150 may be employed. For example, a first cloud computing environment may store receipt information and supplemental content and provide access to the receipts and supplemental content from a user device 110 connected to the first cloud computing environment, and a second cloud computing environment may provide security information, such as lists of non-trusted merchants, to the payment application 111. Although the illustrated environment includes a cloud computing environment 150, other types of computing environments, such as a client-server environment may be used instead.

The merchant system 130 and the user device 110 can communicate using a defined messaging protocol. The payment application 111 can encode a message using the protocol and send the encoded message to the POS terminal 134 or the web server 131, where the message is decoded using the protocol. Similarly, the merchant system 130 can encode a message using the protocol and send the encoded message to the image purchase application 111 where the message is decoded using the protocol.

One or more of the components of the exemplary operating environment 100, such as the user device 110, the payment processor 132, and the POS terminal 134 can include one or more computer systems, such as the computer system 200 illustrated in FIG. 2. Referring to FIG. 2, the computer system 200 includes a processing unit 221, a system memory 222, and a system bus 223 that couples system components, including the system memory 222, to the processing unit 221. The system bus 223 can include any of several types of bus structures, including a memory bus or memory controller, a peripheral bus, or a local bus, using any of a variety of bus architectures. The system memory 222 includes a read-only memory (ROM) 224 and a random access memory (RAM) 225. A basic input/output system (BIOS) 226 containing the basic routines that help to transfer information between elements within the computer system 200, such as during start-up, is stored in the ROM 224.

The computer system 200 also includes a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM, compact disk-read/write (CD/RW), DVD, or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary computer system 200 employs a ROM 224, a RAM 225, a hard disk drive 227, a removable magnetic disk 229, and a removable optical disk 231, other types of computer-readable media also can be used in the exemplary computer system 200. For example, the computer-readable media can include any apparatus that can contain, store, communicate, or transport data for use by or in connection with one or more components of the computer system 200, including any electronic, magnetic, optical, electromagnetic, infrared, or semiconductor system (or apparatus or device) or medium, such as magnetic cassettes, flash memory cards, digital video disks, Bernoulli cartridges, and the like. The drives and their associated computer-readable media can provide nonvolatile storage of computer-executable instructions, data structures, program modules, and other data for the computer system 200.

A number of modules can be stored on the ROM 224, RAM 225, hard disk drive 227, magnetic disk 229, or optical disk 231, including an operating system 235, an application module 238, and the web browser application 112 and the image purchase application 111 discussed above in connection with FIG. 1. The web browser application 112, the purchase application 111, and application module 238 can include routines, sub-routines, programs, objects, components, data structures, etc., which perform particular tasks or implement particular abstract data types.

The user 101 can enter commands and information to the computer system 200 through input devices, such as a keyboard 240, and a pointing device 242. The pointing device 242 can include a mouse, a trackball, an electronic pen that can be used in conjunction with an electronic tablet, or any other input device, such as a microphone, joystick, game pad, satellite dish, scanner, or the like. These and other input devices are often connected to the processing unit 221 through a serial port interface 246 that is coupled to the system bus 223, but can be connected by other interfaces, such as a parallel port, game port, a universal serial bus (USB), or the like. A display device 247, such as a monitor, also can be connected to the system bus 223 via an interface, such as video adapter 248. In addition to the display device 247, the computer 220 can include other peripheral output devices, such as speakers (not shown) and a printer 243.

The computer system 200 is configured to operate in a networked environment using logical connections to one or more remote computers 249. The remote computer 249 can be any network device, such as a personal computer, a server, a client, a router, a network PC, a peer device, or other device. While the remote computer 249 typically includes many or all of the elements described above relative to the computer system 200, only a memory storage device 250 has been illustrated in FIG. 2 for simplicity. The logical connections depicted in FIG. 2 include a LAN 204A and a WAN 204B. Such networking environments are commonplace in offices, enterprise-wide computer networks, intranets, and the Internet.

When used in a LAN networking environment, the computer system 200 is often connected to the LAN 204A through a network interface or adapter 253. When used in a WAN networking environment, the computer system 200 typically includes a modem 254 or other means for establishing communications over the WAN 204B, such as the Internet. The modem 254, which can be internal or external, is connected to system bus 223 via a serial port interface 246.

The computer system 200 is configured to operate in a wireless communication environment using logical connections to one or more user devices 110. The computer system 200 can communicate with the user device 110 using a wireless technology such as NFC communication link, BLUETOOTH, local area network (LAN), a wide area network (WAN), an intranet, an Internet, or other suitable wireless technology. The user device 110 can be any wireless communication device such as, for example, a personal computer, mobile device, (for example, notebook computer, tablet computer, netbook computer, e-Reader, personal digital assistant (PDA), video game device, GPS locator device, cellular telephone, smartphone, or other mobile device), electronically enabled key fobs, electronically-enabled credit card-type cards. The user device 110 can be NFC enabled or is coupled to an NFC enabled device, or capable of being coupled to the computer system 200 via an other suitable wireless technology. The logical connection with the user device 110 is depicted in FIG. 2 to include an NFC connection 204C. In the exemplary embodiment, the network interface 253 of the computer system 200 can include a resonant loop antenna circuit (not shown) having an antenna and a variable component. The resonant loop antenna circuit can be configured to induce a short-range radio frequency field between the antenna of the computer system 200 and an antenna of the user device 110 to establish the NFC communication link 204C. In an alternate embodiment, the resonant loop antenna circuit can be configured to receive the short-range radio waves transmitted by the antenna of the user device 110 to establish the NFC communication link 204C.

It will be appreciated that the network connections shown are exemplary and other means of establishing a communications link between the computers can be used. Moreover, those having ordinary skill in the art having the benefit of the present disclosure will appreciate that the computer system 200 illustrated in FIG. 2 can have any of several other suitable computer system configurations. Furthermore, those skilled in the art having the benefit of the present disclosure will recognize that certain components of the computer system 200 may be added, deleted, or modified in certain alternative embodiments. For example a user device 101 embodied as a mobile phone or handheld computer may not include all the components depicted in FIG. 2 and/or described above.

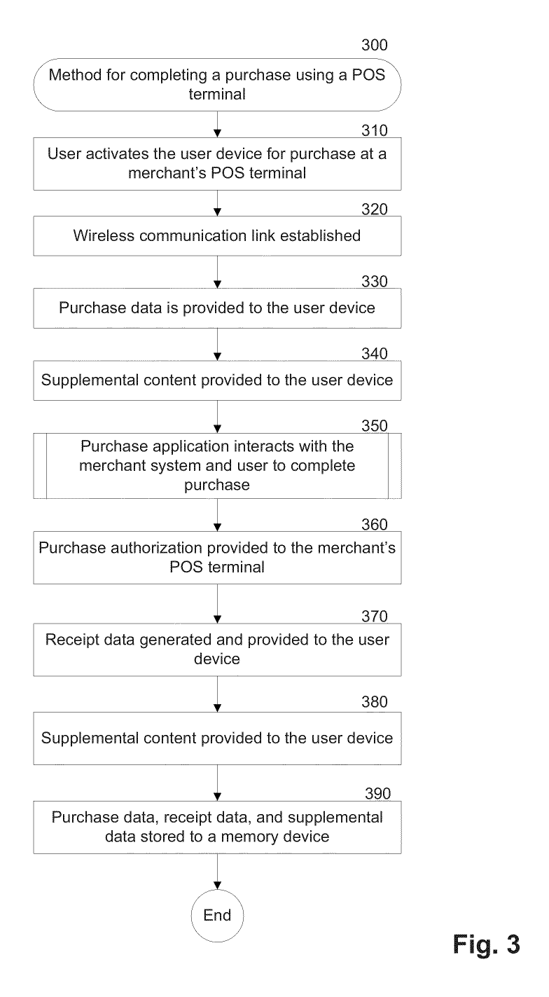

The components of the exemplary operating environment 100 have been described with reference to the exemplary systems illustrated in FIGS. 1-2. The exemplary operating environment 100 can include one or more methods or computer programs that embody the functions described herein and illustrated in FIG. 3. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 3 is a flow chart depicting a method 300 for completing a purchase using a POS terminal 134 and providing supplemental content to the user 101, in accordance with certain exemplary embodiments. With reference to FIGS. 1 and 3, the user 101 can activate the user device 110 for purchase, for example, by placing the user device 110 in proximity to the POS terminal 134, by launching an application, or by pressing a physical or virtual button on the user device 110. (Step 310). A wireless communication link is then established between the user device 110 and the POS terminal 134. In an exemplary embodiment, the wireless communication link utilizes a wireless technology, such as NFC, BLUETOOTH, a local area network (LAN), a wide area network (WAN), an intranet, an Internet, or other suitable wireless technology. (Step 320).

Purchase data is provided from the POS terminal 134 to the user device 110. (Step 330). In an exemplary embodiment, the purchase data can include information regarding the item(s) being purchased. For example, the purchase data can include a description of the product or service being purchased (e.g., title, brand, model, material, quality), a quantity of the product identifier, purchase price, unique identifier associated with the item being purchased (e.g., ISBN number, SKU number, catalog number), and the location. Where the product/service being purchased is associated with a particular date and/or time (e.g., movie ticket), the purchase data may include an indication of date, time, and duration of the product/service.

In an exemplary embodiment, supplementary content associated with the anticipated purchased can be provided to the user device 110 before the purchase transaction is complete. (Step 340). The supplemental content can include, for example, a document, electronic media file, and computer-implemented instructions. The supplemental content may be based on information associated with the user 101, information associated with the product or service of interest, and/or information associated with the merchant system 130. For example, the supplemental content may include a description or price information of the product, a promotion or advertisement associated with purchase of the product, computer-implemented instructions to confirm availability on the user's 101 or another user's digital calendar for a date and time associated with the product.

The payment application 111 of the user device 110 interacts with the merchant system 130 and the user 101 to complete the purchase. (Step 350). The payment processor 132 can send a purchase request message to the payment application 111 via the POS terminal 134. The purchase request message can include a request for payment information and can further include information regarding the requested purchase, such as information associated with the selected products and information associated with the merchant system 130. In response to receiving the purchase request message, the payment application 111 can present a user interface to the user 101 for the user 101 to confirm the purchase. The user interface can also allow the user 101 to select from multiple payment options to send to the POS terminal 134.

After the user 101 confirms the purchase, a purchase authorization is sent to the POS terminal 134. (Step 360). The purchase authorization can include payment information, such as, credit card or bank account information associated with the user 101, a loyalty rewards account information, or any other type of account that can provide payment for the purchase. The purchase authorization can also include information associated with the user 101 including, for example, name and contact information, demographic information, purchase history, loyalty account information, and any other information associated with the user 101 that may be relevant to the transaction or requested specifically by the merchant. The payment processor 132 can interact with an acquirer or the financial institution associated with the payment information to authorize the purchase.

Once the purchase authorization has been received and the transaction complete, receipt data can be generated by the merchant system 130 and provided to the user device 110. (Step 370). The receipt data can include, for example, confirmation of purchase, information associated with the purchase, such as a list of products purchased, a description of each product purchased, the price for each product purchased, a product category for each product purchased, a total price, a unique identifier associated with purchased item(s) (e.g., ISBN number, SKU number, catalog number), taxes paid, rebates for product(s) purchased, payment method used, discounts applied, the time and/or date of purchase, warranty information for product(s) purchased, or other suitable information. The receipt data may also provide user 101 specific data including, for example, the payment method used, loyalty account information, user registration/warranty information, a user's 101 digital signature, etc. The receipt data can also include information regarding the merchant associated with the merchant system 130, including a name of the merchant, a description of the merchant, the purchase location, the URL of the merchant's website 133, and other suitable information regarding the merchant or the merchant system 130.

Once the purchase authorization has been received and the transaction is complete, supplemental content may again be provided to the user 101. (Step 380). It is contemplated that the supplemental content may be provided before, after, or both before and after the purchase transaction has been complete. The supplemental content provided before completion of the purchase transaction can be either the same or different from the supplemental content provided after the transaction has been completed. In an exemplary embodiment, the supplemental content provided after completion of the purchase transaction may be provided at a location and/or time other than the location or time where the purchase data was provided. For example, where the product is a movie ticket, the purchase data may be provided at a box office or kiosk associated with the POS terminal 134. The post-transaction supplemental content may be provided when the user 101 is away from the POS terminal 134. In the present example, the post-transaction supplemental content may be provided at a time proximate to the anticipated start time of the film, or where the user device 110 is determined to be at a specific position either by the use of the positioning components of the phone or by the use of a wireless communication device (e.g., NFC communication link, far-field communication, WAN, LAN, intranet, Internet) associated with the merchant system 130. For example, the user 101 may receive the supplemental content at a time when the movie is scheduled to be complete or when it is determined that the user 101 is located at a predetermined position, e.g., when the user 101 has entered the theater seating area. In this manner, the supplemental content may be provided to the user 101 at a time and/or location relevant to the purchased product and/or the merchant system 130.

In an exemplary embodiment, the purchase data, receipt data, supplemental data, and any additional data generated or otherwise associated with the purchase transaction may be stored to the data storage unit 113 associated with user device 110. (Step 390). In another exemplary embodiment, the purchase data, receipt data, supplemental data, and any additional data generated or otherwise associated with the purchase transaction may be stored to a memory device (not shown) associated with merchant system 130. (Step 390). It is contemplated that data stored to either the data storage unit 113 or the memory device may be retrieved, modified, and/or removed using either the user device 110 or the merchant system 130. In an exemplary embodiment, the data storage unit 113 and the memory device can be synchronized with the cloud computing environment 150 by sending the data to the web server 151. The web server 151, in turn, stores, received data in the data storage unit 152 within the cloud computing environment 150. It is contemplated that data stored in the data storage unit 152 may be retrieved, modified, and/or removed using the web server 151. From Step 390, the method 300 ends.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A method for providing data to a wireless device comprising:
transmitting purchase data via near-field communication to the wireless device;
receiving, via near-field communication from the wireless device, purchase authorization data for a purchase transaction at a payment module coupled to a merchant computing device;
identifying, by the merchant computing device, supplemental data associated with the purchase data; and
responsive to receiving the purchase authorization data via near field communication, transmitting the supplemental data associated with the purchase data to the wireless device,
wherein the supplemental data includes at least one of instructions to download content associated with the supplemental data and instructions to update a digital calendar based on at least one of the supplemental data and the purchase data.

2. The method of claim 1, wherein the supplemental data comprises at least one of a document, an electronic media, and computer-implemented instructions.

3. The method of claim 2, wherein the supplemental data comprises at least one of an image file, an audio file, a video file, and a link to a website.

4. The method of claim 2, wherein the computer-implemented instructions comprise instructions to direct a user interaction with a social media website.

5. The method of claim 1, wherein the supplemental data is determined based on at least one of a user selection, information associated with a user, information associated with an item being purchased, and information associated with a merchant.

6. (canceled)

7. The method of claim 1, wherein the instructions to update the digital calendar comprise instructions to update the digital calendar associated with a user of another device.

8. The method of claim 7, wherein updating the digital calendar associated with the user of the other device comprises:
requesting availability information associated with the user of the other device;
providing an event request to the user of the other device; and
receiving an indication of acceptance of the event request from the user of the other device.

9. The method of claim 1, wherein the supplemental data comprises at least one of a warranty associated with a product, a rebate for the product, a discount applied to the purchase of the product, and a coupon for a future purchase.

10. The method of claim 1, wherein the supplemental data is provided via near-field communication.

11. The method of claim 1, wherein the supplemental data is provided by a communication type other than near-field communication.

12. The method of claim 11, wherein the supplemental data is provided when the wireless device is at a location other than a location where the purchase data was provided.

13. The method of claim 1, further comprising:
generating at the payment module an electronic data item comprising receipt data associated with the purchase data, and
storing, by the payment module, the supplemental data and the receipt data in a memory device logically coupled to the merchant device.

14. A mobile wireless communication device comprising:
an electronic antenna circuit to transmit and receive data via near-field communication (NFC); and
control circuitry coupled to the electronic antenna circuit to control transmission of the data via near-field communication, the data including purchase authorization data,
wherein the data received by the electronic antenna circuit includes purchase transaction data,
wherein responsive to receiving the purchase transaction data, the control circuitry controls NFC transmission of the purchase authorization data via the electronic antenna circuit,
wherein the control circuitry controls the electronic antenna circuit to receive supplemental data responsive to transmitting the purchase authorization data;
wherein the control circuitry identifies content associated with the supplemental data and instructs the electronic antenna circuit to retrieve the desired content associated with the supplemental data.

15. The device of claim 14, wherein the control circuitry identifies desired content based on a user selection, information associated with a user, information associated with an item being purchased, and information associated with a merchant.

16. The device of claim 14, further comprising a memory device logically coupled to the control circuitry for storing the purchase transaction data and the supplemental data.

17. The device of claim 14, wherein the supplemental data comprises instructions to update a digital calendar associated with a user of the wireless communication device based on at least one of the supplemental data and the purchase transaction data.

18. The device of claim 14, wherein the supplemental data comprises instructions to schedule a calendar event on a digital calendar associated with another user.

19. The device of claim 14, wherein the supplemental data comprises at least one of a document, an electronic media, and computer-implemented instructions.

20. The device of claim 14, wherein the supplemental data is received by a communication type other than near-field communication.

21. The device of claim 20, wherein the supplemental data is provided when the wireless device is at predetermined location other than a location where the purchase transaction data was provided.

22. A wireless communication device utilizing near-field communications, the device comprising:
an electronic antenna circuit including an antenna to transmit and receive data via near-field communication between the wireless communication device and a mobile device; and
control circuitry coupled to the electronic antenna circuit, the control circuitry to control transmission of the data to the mobile device, the data including purchase data and supplemental data associated with the purchase data,
wherein the control circuitry provides the supplemental data to the mobile device in response to receipt of purchase authorization data from the mobile device, and
wherein the supplemental data includes at least one of instructions to download content associated with the supplemental data and instructions to schedule a calendar event on a calendar associated with a user of the mobile device.

23. The device of claim 22, wherein the control circuitry is further configured to identify the supplemental data based on at least one of a user selection, information associated with a user, information associated with an item being purchased, and information associated with a merchant.

24. The device of claim 22, wherein the supplemental data comprises at least one of a document, an electronic media, and computer-implemented instructions.

25. The method of claim 22, wherein the instructions to schedule a calendar event comprise instructions to update a digital calendar associated with a user of the mobile device.

26. The device of claim 22, further comprising a memory device logically coupled to the control circuitry configured to store at least one of the purchase data, the supplemental data, and the purchase authorization data.

27. The device of claim 26, wherein the memory device comprises a cloud computing environment.

28. The device of claim 22, wherein the supplemental data is provided when the mobile device is at location other than a location where the purchase data was provided.
